(19) United States
(12) Patent Application Publication
(10) Pub. No.: US 2015/0272133 A1
(43) Pub. Date: Oct. 1, 2015

(54) INSECT REPELLANT COMPOSITIONS

(71) Applicant: Philip G. Freeman, Raleigh, NC (US)

(72) Inventor: Philip G. Freeman, Raleigh, NC (US)

(21) Appl. No.: 14/242,180

(22) Filed: Apr. 1, 2014

(51) Int. Cl. A01N 65/44; A01N 25/20; A01N 65/22

(52) U.S. Cl. CPC A01N 65/44; A01N 65/22; A01N 25/20

(57) ABSTRACT

Provided is a composition for repelling insects, for example, mosquitoes. The composition comprises citronella oil, lemongrass oil and rosemary oil, and a carrier. The composition of the invention may be provided on an incense stick, incense coil, incense cone or in a candle, which may be smoldered or burnt in order to produce its insect repelling functions.

### FIELD OF THE INVENTION

The present invention relates to compositions for repelling insects. More particularly, the present invention relates to compositions for repelling insects comprising ingredients that are exempt from federal registration under §25(b) of the Federal Insecticide, Fungicide and Rodenticide Act.

### BACKGROUND OF THE INVENTION

Insect repellents have long been used to prevent insects from annoying humans and animals. Such repellents have also been used to prevent insect harm to items such as food, clothing and furniture. Traditional repellents include candles made from citronella oil and mothballs, which contain chemicals such as camphor, para-dichlorobenzene and napthalene, and/or cedar wood. Synthetic chemicals have also been developed, for example, 2-ethyl-3-hexanediol, DDT and DEET (N,N-diethyl-meta-toluamide), the latter of which is the active ingredient in such commercially available insect repelling products as OFF®. However, many of these synthetic ingredients in commercially available compositions for repelling insects or pests are not only toxic to the target insect or pest, but also humans and/or household pets at sufficient amounts, concentration or exposure. Moreover, many of these ingredients at lesser exposures possess various undesirable side effects, which may be exacerbated in individuals with heightened sensitivity, or in children or babies. Additionally, for example, DEET is suspected to by a carcinogen, teratogen and/or mutagen. As such, limits have been placed in many municipalities on the percentage of synthetic chemicals, such as DEET, in any composition or formulation for human or animal use.

Many naturally occurring substances have been found to be insect repellents or insecticides in nature. Essential oils, for example, of various plants repel certain insects and are not believed to cause genetic mutations. As such, there have been efforts to develop compositions which are effective at repelling insect pests that are non-toxic to humans and pets. The Environmental Protection Agency (EPA) regulates the use of potentially toxic ingredients in compositions for controlling pests under the Federal Insecticide, Fungicide and Rodenticide Act (FIFRA). Certain materials and compounds have been identified by the EPA as acceptable or safe substances that provide minimal risk to humans in normal use, and have been deregulated by the EPA. The present invention seeks to provide improved compositions for repelling insects and methods for repelling insects using the same.

### SUMMARY OF THE INVENTION

Thus in an aspect of the invention, provided is a composition for repelling insects comprising ingredients, more particularly oils, that have been deregulated by the EPA that lessen human and animal health risk and environmental impact and remove the burden of regulation that may be encountered with conventional synthetic insecticides or repellents.

In a further aspect of the invention, provided is an insect repellant composition, comprising oils from various plants, namely, citronella, lemongrass and rosemary, and a carrier, that has a pleasant fragrance.

In another aspect of the invention, provided is an insect repellant incense stick comprising a composition comprising oils from various plants, namely, citronella, lemongrass and rosemary.

In yet another aspect of the invention, provided is an insect repellant candle comprising a composition comprising oils from various plants, namely, citronella, lemongrass and rosemary.

In yet another aspect of the invention, provided is a method for repelling insects, e.g., mosquitoes, comprising burning or smoldering of an incense stick comprising an insect repellant composition comprising oils from various plants, namely, citronella, lemongrass and rosemary.

In yet another aspect of the invention, provided is a method for repelling insects, e.g., mosquitoes, comprising burning of a candle comprising an insect repellant composition comprising oils from various plants, namely, citronella, lemongrass and rosemary, for repelling insects.

### DETAILED DESCRIPTION

The present invention will now be described with reference to the accompanying drawings, in which representative embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

The terminology used herein is for the purpose of describing particular embodiments only and is not intended to be limiting of the invention. As used herein, the singular forms “a,” “an,” and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The terms “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

The term “about,” as used herein when referring to a measurable value such as a dosage or time period and the like, is meant to encompass variations of, for example, ±20%, ±15%, ±10%, ±5%, ±4%, ±3%, ±2%, ±1%, ±0.5%, or even ±0.1% of the specified amount.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In accordance with an embodiment of the present invention, provided is a composition for repelling insects. The composition of the invention comprises compounds and/or mixtures of compounds, for example, oils, more particularly plant-based oils, that have been deregulated by the EPA and are exempt from regulation under FIFRA, and have been identified by the EPA as acceptable or safe substances that provide minimal risk to humans in normal use. In a further embodiment of the invention, the mixture of oils of the invention may be provided in a composition further comprising a carrier. In yet a further embodiment, the mixture of oils of the invention may be provided in a composition further comprising a fragrance. In a particular embodiment, the composition for repelling insects may be for repelling mosquitoes. In yet another embodiment of the invention, the oils in the composition of the invention comprise citronella oil, lemongrass oil and rosemary oil.

The manner in which the oils in the composition of the invention are derived is not particularly limited, so long as the insect repelling characteristics of the oils are maintained. In a further embodiment, additives that protect the oils from degradation, e.g., oxidation, may be included in the composition to lengthen the shelf life of the composition, or may provide a means in which the composition of the invention is retained and provided so that it may be dispersed in order to repel insects.

The carrier can be any that would be appreciated by one of skill in the art. Although not particularly limited, in one embodiment the carrier may comprise an absorbent combustible material, such as a sawdust material, for example, a bamboo sawdust material. The carrier in the composition of the invention may also comprise a binder so as to provide a combustible base, such that the composition of the invention is be suitable for covering or coating, for example, the outer or top end of a stick, which may be burned or smoldered, such as an incense stick, or formed into a structure. The combustible base may be provided to not only bind the components of the composition of the invention together but also allow the produced composition to burn with a self-sustained ember, which propagates slowly and evenly through an entire piece of incense. The combustible base can be chosen such that it does not produce a perceptible smell.

In another embodiment, the composition of the invention may be formed into any suitable shape, either on a core, in which the composition of the invention is coated onto a core structure, such as, but not limited to, a stick or a coil, or without a core, in which the composition of the invention may be formed directly into any shape that would be appreciated by one of skill in the art, such as, but not limited to, a stick, a coil or a cone. In another embodiment, the carrier may be a wax, for example palm wax, paraffin wax, candle tallow, or any material suitable as a candle base, in which the composition of the invention may be provided in the form of a candle.

The fragrance may be any that would be appreciated by one of skill in the art, for example, that would enhance and provide more attractive and more pleasant odors to the composition of the invention when it is in use.

The composition may comprise about 0.1 to about 10% by weight citronella oil, about 0.1 to about 10% by weight lemongrass oil, about 0.1 to about 10% by weight rosemary oil and about 90 to about 95% by weight of a carrier, and in one embodiment the composition may be about 1.5 to about 3% by weight citronella oil, about 1.5 to about 3% by weight lemongrass oil, about 2 to about 4% by weight rosemary oil, and about 90 to about 95% by weight of a carrier. In a particular embodiment of the invention, the mixture of oils in the composition of the invention provided may be present in particular ratios of particular oils, for example, plant-based oils, and particular ratios of total oils to carrier. For example, the particular plant-based oils may comprise citronella oil, lemongrass oil and rosemary oil, which are present in the composition of the invention at particular ratios. For example, the ratio may be about 3 to about 3 to about 4 parts (3:3:4) of citronella oil to lemongrass oil to rosemary oil. In another embodiment, the ratio may be about 1 to about 1 (1:1) of citronella oil to lemongrass oil. In another embodiment, the ratio may be about 3 to about 4 (3:4) of citronella oil to rosemary oil or about 3 to about 4 (3:4) of lemongrass oil to rosemary oil. In another embodiment, the ration may be about 6 to about 4 (6:4) of the sum of the amount of citronella oil and lemongrass oil to rosemary oil.

The mixture of oils may be provided with a carrier at particular ratios of total oils to carrier. In some embodiments, the amount of carrier to total oils is from about 90 parts carrier to about 10 parts total oil (90:10) to about 95 parts carrier to about 5 parts total oils, i.e., the composition may comprise about 90 to about 95% carrier. The same composition may comprise from about 5 to about 10% total oils. An exemplary composition may comprise about 3% citronella oil, about 3% lemongrass oil, about 4% rosemary oil and about 90% carrier. In this embodiment, the carrier may comprise sawdust, for example, bamboo sawdust, and optionally, a binder.

Another exemplary composition may comprise about 1.5% citronella oil, about 1.5% lemongrass oil, about 2% rosemary oil and about 95% carrier. In this embodiment, the carrier may be a wax, for example, a wax that is suitable for making a candle, i.e., a candle wax, such as a paraffin wax, palm wax, candle tallow or the like. In other embodiments, additional fragrances may be added to the composition of the invention in place of a portion of the carrier, for example, about 0.1, about 0.5, about 1, about 1.5, about 2%, about 2.5% or about 3%.

The particular combination of oils in the compositions of the present invention may also provide a synergistic effect, i.e., provide enhanced insect repelling activity over that which would not have been predicted by one of skill in the art for the individual oils alone or in combination, such as is with the particular oils, citronella oil, lemongrass oil and rosemary oil, in the particular ratios, about 3:3:4 citronella oil to lemongrass oil to rosemary oil, in the total amounts, about 5% to about 10% of the composition, as set forth above.

In yet another embodiment of the invention, the composition for repelling insects may be provided on an incense stick formed of a wood, for example, bamboo. The incense stick may comprise a core shaft covered at the outer or top end of the stick with the composition of the invention wherein the carrier may be an absorbent combustible material, for example, a combustible sawdust material that has been reduced to a spongy cellulose form in which the oil or oils of the invention are impregnated and/or retained in the carrier. In one embodiment, the absorbent combustible material of this composition may be a bamboo sawdust material. The incense stick comprising the composition of the invention may be produced according to any manner that will be appreciated by one of skill in the art and is not particularly limited. The composition of the invention may be coated or to cover the outer or top end of the stick, which, for example, may be about 10 to about 12 inches in length, more particularly about 10 to about 11 inches in length, more particularly about 11 inches in length. The composition of the present invention may be coated on the incense stick with a diameter of about ¼ to about ⅜ inches, more particularly about ¼ to about 5/16 inches, and may extend on the stick from about 7.5 to about 9.5 inches on the stick, more particularly about 9 to about 9.5 inches on the stick.

In yet another embodiment of the invention, the composition for repelling insects may be provided in the form of an incense coil. The form of the coil of the invention is not particularly limited, and the composition for repelling insects of the invention may be blended, processed and formed into a coil, wherein the carrier comprises, for example, bamboo, and a binder, by any conventional manner that would be appreciated by one of skill in the art. The composition of the invention may be, for example, may be formed by way of example, by compression or extrusion, into any desired shape of the coil that might be envisioned by one of skill in the art. The incense coil comprising the composition of the invention may be prepared by forming the composition of the invention on a core structure to provide the coil. Alternatively, the composition of the invention may be formed directly without a core into a coil form by any means that would be appreciated by one of skill in the art.

In yet another embodiment of the invention, the composition for repelling insects may be provided in the form of an incense cone. The incense cone may be formed from the composition of the invention by any conventional manner that will be appreciated by one of skill in the art.

In use, the incense stick, incense coil or incense cone comprising the composition of the invention may first be ignited with a match or the like to produce a flame. The flame can then be blown out, and the incense stick, incense coil or incense cone thereafter continues to smolder and smoke until the composition burns completely, with no flame returning. The time in which the incense stick may completely burn, may be up to 30, 45, 60, 70, 80, 90, 100, 110 or 120 minutes, or for two or more hours, or perhaps even a day or days. When in use, the incense stick, coil or cone comprising to the composition of the invention may be burnt or smoldered near ground level.

The incense stick comprising the composition of the invention may be used in any conventional manner that may be appreciated by one of skill in the art. For example, in an embodiment, the incense stick of the invention may be used by placing the stem of the incense stick into the ground, and igniting the stick.

The incense coil comprising the composition of the invention may be used in any conventional manner as will be appreciated by one of skill in the art. For example, in an embodiment, the incense coil may be hung off the ground on a support, wherein it is burned or smoldered. The nature of the support from which the incense coil is supported is not particularly limited, and may be any structure that may be appreciated by one of skill in the art adapted to support an incense coil that is hung therefrom. In still other embodiments, the incense coil may be used by burning or smoldering at ground level.

In use, the incense cone comprising the composition of the invention may be burned or smoldered by any conventional manner that would be appreciated by one of skill in the art. For example, the incense cone may be burned or smoldered in an incense cone holder or an incense cone burner.

More than one stick, coil or cone can be ignited, wherein incense sticks separated by, for example, about 12 feet to about 15 feet, in order to repel insects, for example, mosquitoes, over a larger area than can be provided by the burning or smoldering of a single incense stick, coil or cone.

In another embodiment, the incense stick or cone may be placed and burned or smoldered in a diffuser.

In yet another embodiment, the composition for repelling insects of the invention may be provided in a candle. The candle comprising the composition of the present invention in not particularly limited in dimension and/or size. The wick of the candle is not particularly limited, and any suitable wick may be used as would be understood by one of skill in the art, and although the wax or the base material of the candle is not particularly limited, it should be of a nature such that the oil and the mixture of oils in the composition of the invention may be homogenously mixed into the wax or candle base material in the molten condition. In an embodiment of the invention, the base material of the candle is palm wax.

In use, the candle comprising the composition of the invention may be lit and burned for a period of time, for example, for about 1, about 1.5, about 2, about 3, about 5, about 7, about 10, about 12 or about 15 hours, either continuously or intermittently. More than one candle can be lit, wherein candles separated by, for example, about 12 feet to about 15 feet, in order to repel insects, for example, mosquitoes, over a larger area than can be provided by the lighting of a single candle. The candle comprising the composition of the invention may be used in any manner that would be appreciated by one of skill in the art. For example, the candle may be burned either free standing on its own or in a candle holder. The candle may be burned either at ground level or on a table or in a holder above ground level.

The foregoing is illustrative of the present invention, and is not to be construed as limiting thereof. The invention is defined by the following claims, with equivalents of the claims to be included therein.

That which is claimed is:

1. A composition for repelling insects comprising citronella oil lemongrass oil, rosemary oil and a carrier.

2. The composition of claim 1, comprising about 1.5 to about 3% by weight citronella oil, about 1.5 to about 3% by weight lemongrass oil, about 2 to about 4% by weight rosemary oil and about 90 to about 95% by weight of a carrier.

3. The composition of claim 1, wherein the citronella oil, lemongrass oil and rosemary oil comprise about 5 to about 10% by weight of the composition.

4. The composition of claim 1, wherein the ratio of citronella oil to lemongrass oil to rosemary oil is about 3 to about 3 to about 4 (3:3:4).

5. The composition of claim 1, wherein the ratio of citronella oil to lemongrass oil is about 1 to about 1 (1:1).

6. The composition of claim 1, wherein the ratio of citronella oil to rosemary oil or the ratio of lemongrass oil to rosemary oil is about 3 to about 4 (3:4).

7. The composition of claim 1, wherein the ratio of citronella oil and lemongrass oil combined to rosemary oil is about 6 to about 4 (6:4).

8. The composition of claim 1, wherein the carrier comprises sawdust.

9. The composition of claim 8, wherein the sawdust comprises bamboo sawdust.

10. The composition of claim 1, wherein the carrier comprises a binder.

11. The composition of claim 1, wherein the carrier is a wax.

12. The composition of claim 11, wherein the wax is palm wax.

13. An incense stick comprising the composition of claim 1.

14. An incense coil comprising the composition of claim 1.

15. An incense cone comprising the composition of claim 1.

16. A candle comprising the composition of claim 1.

17. A method of repelling insects comprising burning or smoldering the incense stick of claim 13.

18. The method of claim 17, wherein the insects are mosquitoes.

19. A method of repelling insects comprising burning or smoldering the incense coil of claim 14.

20. The method of claim 19, wherein the insects are mosquitoes.

21. A method of repelling insects comprising burning or smoldering the incense cone of claim 15.

22. The method of claim 21, wherein the insects are mosquitoes.

23. A method of repelling insects comprising burning the candle of claim 16.

24. The method of claim 22, wherein the insects are mosquitoes.
